(19) United States
(12) Patent Application Publication
(10) Pub. No.: US 2010/0005059 A1
(43) Pub. Date: Jan. 7, 2010

(54) Cascaded Address Books on Mobile Phones Within a Social Network

(75) Inventors: Dwip N. Banerjee, Austin, TX (US); Aditya Mohan, Dublin (IE); Sandeep Ramesh Patil, Pune (IN); Venkat Venkatsubra, Austin, TX (US)

Correspondence Address: DUKE W. YEE;YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/166,565

(22) Filed: Jul. 2, 2008

(51) Int. Cl. G06F 17/30

(52) U.S. Cl. 707/3; 707/E17.001

(57) ABSTRACT

Illustrative embodiments provide a computer implemented method, a data processing system and a computer program product for locating contact information in a mobile phone network within a social network. In one embodiment, the computer implemented method permits reciprocal access between a first user's contact information and a second user's contact information by a first user device and a second user device, and permitting reciprocal access between the second user's contact information and a third user's contact information by the second user device and a third user device. The computer implemented method receives a request from the third user device to contact the first user device, wherein the first user contact information is unknown to the third user and issues a search on the mobile phone network, from the third user device, for the first user contact information. The first user contact information is located at the second user device in the social network, and the first user contact information is returned to the third user device.

### BACKGROUND OF THE INVENTION

1. Field of the Invention

The present invention relates generally to an improved data processing system and more specifically to a computer implemented method, an apparatus and a computer program product for cascaded address books on mobile phones within a social network.

2. Description of the Related Art

Communication over mobile phone frequently presents a situation for a calling user, the caller, where the contact number of the intended recipient is not available in the caller's local phone address book. Typically in these situations, the caller may know another contact in the caller's address book that may have the desired contact number in the contact's own phone address book. The caller may also have access to a phone book to look up the needed number. The phone book may be printed or available online. Currently available methods of locating and using a phone book, whether online or printed, are cumbersome. If a third party user has to be called for the desired number or contact information, the third party user may view the request as invasive. If the third party user is out of the signal coverage area or not able to pick up the phone, for example because they are driving, the caller may have to wait and retry later until the third party user is available. Moreover there is a possibility for error and delay in a verbal communication.

Each user generally attempts to be self sufficient and therefore may have added as many numbers as thought were needed to the mobile address book. However, this is not achievable in a dynamic and ever growing social network, and across relationships among various social groups. The constant addition of entries would further lead to a disadvantage in which the address book would become bulky and at a certain point in time, relevance for some of the entries may be lost.

Another approach would allow users who consider themselves part of a social network to come together to form a common or shared address book accessible over the web. The shared address book provides an indirect listing means and involves a maintenance responsibility of the address book as well as access permission. Further, access to such an address book is available only through wireless application protocol (WAP) enabled mobile phones, which may therefore imposes usage restrictions. Thus, the proposed solution overcomes the above shortcomings and presents mobile phone users with an enhanced, user convenient, and non-invasive approach.

### BRIEF SUMMARY OF THE INVENTION

According to one embodiment of the present invention, a computer implemented method, for locating contact information in a mobile phone network within a social network is provided. The computer implemented method permits reciprocal access between a first user contact information and a second user contact information by a first user device and a second user device, and permitting reciprocal access between the second user contact information and a third user contact information by the second user device and a third user device. The computer implemented method receives a request from the third user device to contact the first user device, wherein the first user contact information is unknown to the third user and issues a search on the mobile phone network, from the third user device, for the first user contact information. The first user contact information is located at the second user device in the social network, and the first user contact information is returned to the third user device.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a wireless communication device in accordance with an illustrative embodiment;

FIG. 4 is a block diagram of cascade address book manager components in accordance with illustrative embodiments;

FIG. 5 is a block diagram illustrating caller interaction using contact and authorized user list information, in accordance with illustrative embodiments; and

FIG. 6 is a flowchart of a cascade address book management process in accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

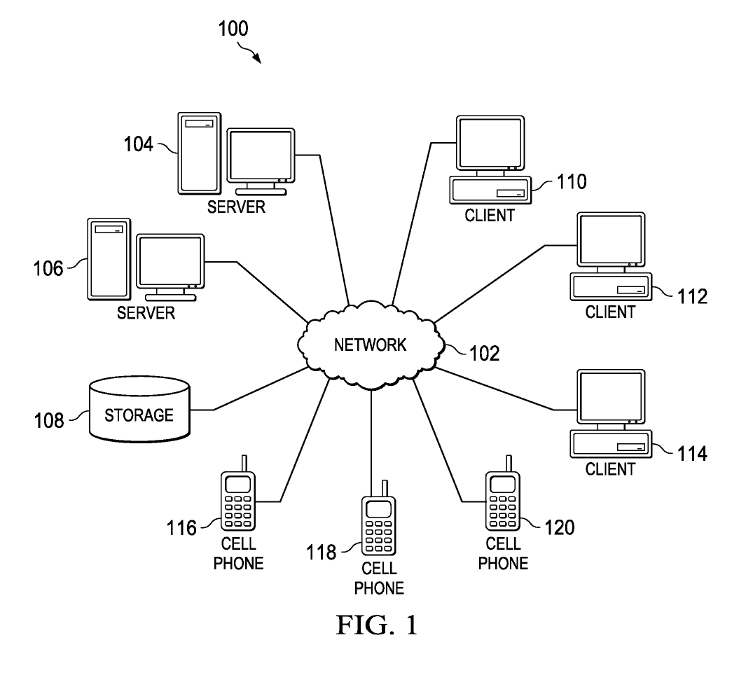

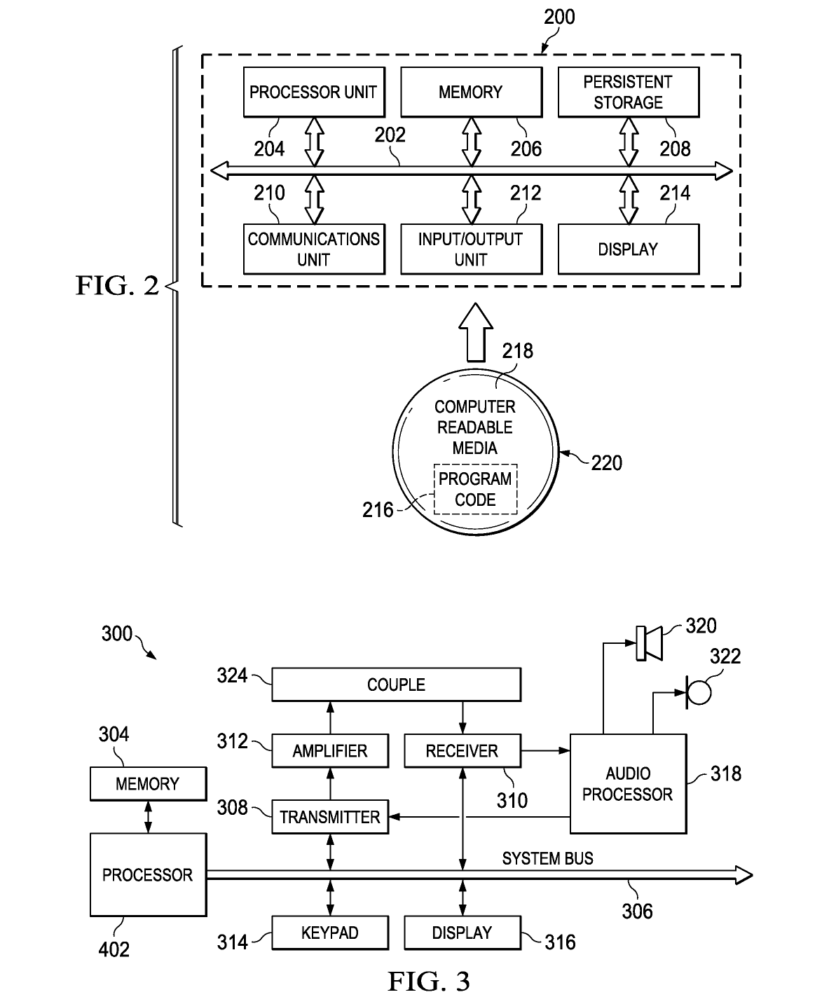

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

For example, one illustrative embodiment enables publicly accessible entries on a particular mobile cell phone to be searchable from participating mobile cell phones of a social network with users having the choice of designating specific members of the social network as trusted. The designation of specific members of the social network creates a secure cascaded address book system across the group of users. An enhanced search capability providing an intelligent searching mechanism, in collaboration with the mobile service provider, provides a finding service for locating needed contact information among the social network members.

For example, when a caller on cell phone 116, wishes to contact a user on cell phone 120 through network 102 but does not have the user's contact information, the caller on cell phone 116 may request other users to aid in the search for the required contact information. In this example, an enhanced searched would be requested through a phone service provider on a server such as server 106. The enhanced search would use permitted or authorized users to respond to the request for contact information from caller on cell phone 116. A user on cell phone 118 may belong to the social network defined by the authorization to share address book contact information with callers on cell phones 116 and 120. Using the example, a request for the contact information for the user of cell phone 120 is resolved by the address book on cell phone 118 and sent to the user on cell phone 116. The proposed solution in the example, in accordance with an illustrative embodiment, is typically non-invasive to an address book owner and lightweight. Further, it may add to the user convenience with additional business value of being a socially network-based solution.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. Persistent storage 208 may also be a hard drive, a flash memory, a rewritable optical disk, a rewritable magnetic tape, or some combination of the above. The media used by persistent storage 208 also may be removable. A removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

With reference now to FIG. 3, a block diagram of a wireless communication device in accordance with an illustrative embodiment is shown. Wireless communication device 300, an example of cell phone 116 of FIG. 1, includes a processor 302 for controlling operation of the communication device and a memory 304. The processor 302 may be a general-purpose microprocessor operating under the control of instructions stored a memory, such as memory 304, or device-specific circuitry for controlling the operation of the telephone device. Processor 302 is connected by system bus 306 to transmitter 308, receiver 310, keypad 314, display 316, and audio processor 318. Keypad 314 may be a keypad and/or buttons. Display 316 may be any type of display device including a liquid crystal display (LCD) or other known displays, such as a cathode ray tube or active matrix display.

Transmitter 308 and receiver 310 are coupled to a telephone signal by couple 324 to provide full duplex communication. The telephone signal may be provided by an antenna, such as for a wireless telephone. Audio processing circuit 318 provides basic analog audio outputs to speaker 320 and accepts analog audio inputs from microphone 322. Received signals are demodulated and decoded by receiver 310. Transmitter 308 encodes and modulates signals passed to it by processor 302 or audio processor 318. The output of the transmitter is amplified by power amplifier 312 to control the power level at which the signal is transmitted.

Processor 302 or audio processor 318 may detect audible call status information and call status codes received by receiver 310. Memory 304 may include a lookup table associating call status information or call status codes with visual call status information, such as text messages. Processor 302 detects or receives a call status code and displays an appropriate call status message on display 316. Those of ordinary skill in the art will appreciate that the hardware depicted in FIG. 3 may vary.

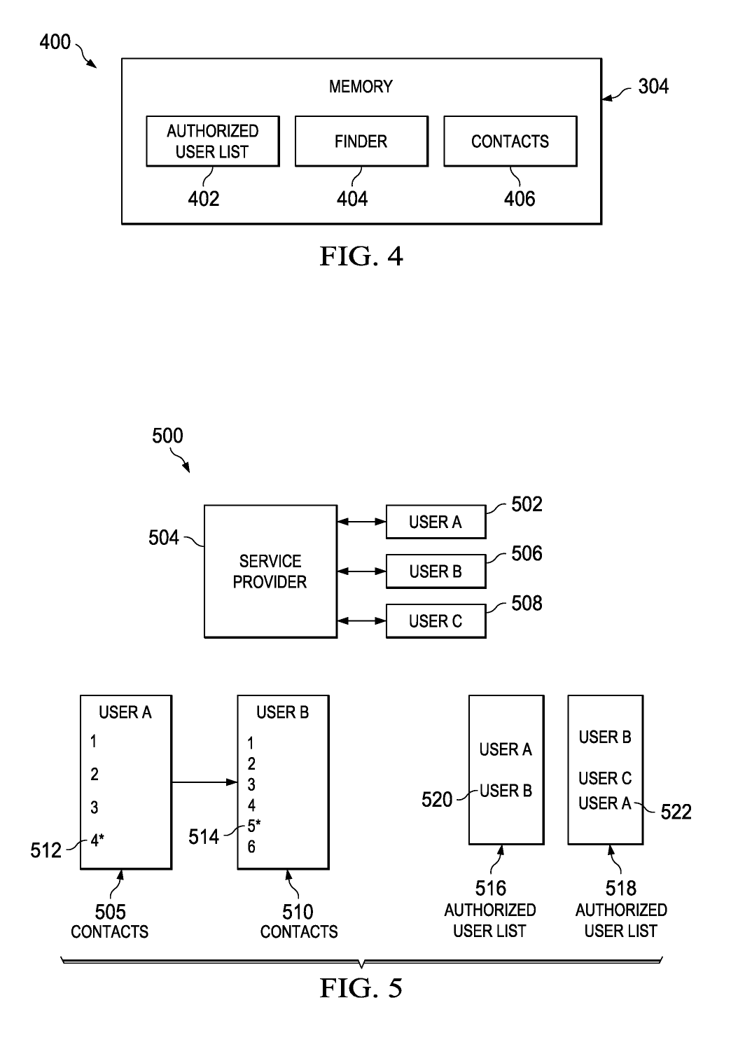

With reference now to FIG. 4, a block diagram of a cascade address book manager components is shown in accordance with illustrative embodiments. Cascade address book manager 400 is shown in this example as being contained within memory 304 of FIG. 3 but may be located in other storage medium prior to actual use, such as storage card. As shown, cascade address book manager 400 contains a number of components comprising authorized user list 402, finder 404 and contacts 406. The components may also be distributed. For example, finder 404 may be located on a phone service provider server such as server 106 of FIG. 1, while a stub finder service exists on the cell phone device to pass a query request to the finder 404. The small device footprint of the cell phone device typically requires more extensive applications to be located on the server devices.

Cascade address book manager 400 provides the overall coordination of requests for extended address book searches as required by the various cell phone device users. The manager provides a common point to apply maintenance and an anchor point for functions to be added or changed. The cascade address book manager 400 provides the service interface to other similar managers on other wireless devices that may have address books wishing to form a social network.

Authorized user list 402 contains the entries for users that have allowed the local device user permission to access the respective remote address books to resolve contact information missing from the requester's local device. It is expected that each authorized user has a reciprocal entry for a corresponding user to allow the cascade address books to occur.

Typically, finder service 404 located on the cascade address book manager is used to broadcast the request for contact information to other authorized users in the form of an enhanced search. The finder service located on the calling device is a stub used to form the request and forward to the phone service provider server for actual broadcast to the identified users.

Contacts 406 are address book entries comprising contact information for the user of the mobile cell phone device. Contact information may be designated as public allowing authorized users to read the entries as required, for example, as a result of an enhanced search request. A social network, in this context of the examples, may be defined as a collection of all the entries within an address book of a particular mobile phone. The collection then constitutes a social network for the user owning this mobile phone.

Enhancement to the attributes for each contact or entry in the mobile phone address book allows users to set the required properties for a contact. Selective updating of the attributes adds to the security. The enhanced attributes prevent unauthorized search requests and allow only authorized contact look up. Entries that a local device trusts may or may not be the same as the set of entries made public for search by other devices of the social network. Therefore being classed as a public entry is not necessarily the same thing as being classed as a trusted entry. For example, a user may provide the contact information for a plumber as a public entry for the benefit of friends and the plumber. The plumber may trust the user and allow the user to provide the plumber contact information as a public entry. The user may not trust the plumber and therefore not want the user information made a public entry in the plumber address book.

With reference to FIG. 5, a block diagram illustrating caller interaction and use of contacts 406 and authorized user lists 402 of FIG. 4 is shown. For example, user A 502 knows user B 506 and each allow the other to access respective address book entries to read contact information. No update or delete access is provided. User B 506 also knows user C 508 and each allow the other to access the respective user's address book. When user C 508 has a need to contact user A 502, but does not know the contact information, user C 508 sends a request for an enhanced search to the phone service provider 504. The request includes identifiers of other users that may have the requested information. The phone service provider 504 sends the request to each identified user and aggregates responses to return to user C 508.

Each user to receive a request has been identified in the address book of user C 508 as cooperating in enhanced search requests from user C 508. For example, a shared/public attribute is defined as an attribute associated with every contact in an address book. When set “true” by the owning user, for example, contact of user A 505, marked as shared entry 512, then the marked contact is made available for search by any other user who has user A 502 defined within the social network and is a member “trusted” by user A 502. In a similar manner, contact of user B 510 has marked entry 514 as being shared. By default all the entries in the address book of a user are private and non-shared. Entries can be made public only by explicitly selecting the shared/public attribute.

A trusted member attribute is defined as an entity in a social network that is being trusted to search the shared/public entries in the address book and uses these to learn or establish communication with other members on social network. A trusted member attribute is associated with each contact in the address book. For example, in the authorized list of user A 516 is found an entry 520 for user B 506. In a similar manner, authorized list of user B 518 has entries 522 in the authorized list for user A 502 and user C 508. The default setting has all contacts set to be non-trusted. The setting can be changed to be made public only by explicitly enabling the trusted member attribute. An owner of the mobile phone device would have the authority to perform the change.

An enhanced search function is defined as a contact search function on mobile phone devices that searches shared local entries in address books. As required, the results of the search query are sent from each responding user to the phone service provider server for mobile telephony. The enhanced search function also verifies that the requester is a valid, trusted member before executing the search.

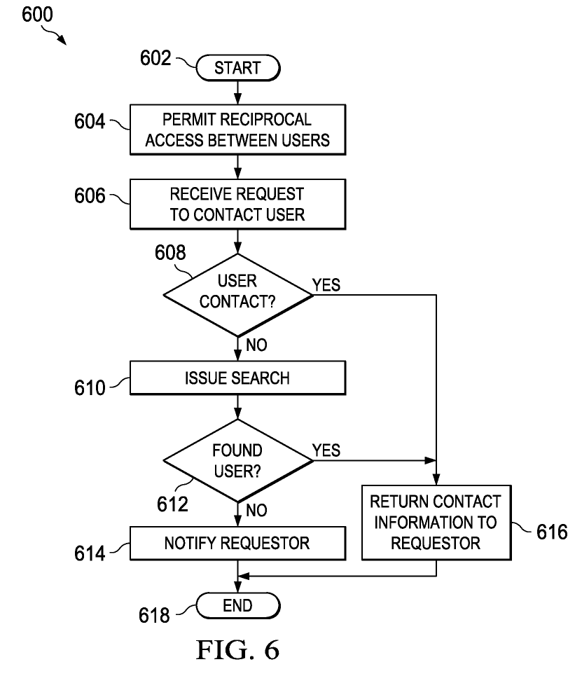

With reference to FIG. 6, a flowchart of cascade address book management process in accordance with illustrative embodiments is shown. Cascade address book management process 600 is an example showing operation of cascade address book manager 400 of FIG. 4.

Process 600 is a process for locating contact information in a mobile phone network within a social network. Process 600 starts (step 602) and permits reciprocal access between users (step 604). Access is between first user contact information and second user contact information by a first user device and a second user device. Additionally, other devices permit reciprocal access between the second user contact information and the third user contact information by the second user device and the third user device. Permitting reciprocal access further comprises forming a trusted pair between the first user device and the second user device and another trusted pair between the second user device and the third user device.

A request to contact a user is received (step 606). For example, the third user device initiates a request to contact the first user device. A determination is made whether the contact information is available locally (step 608). If the contact information is available locally a “yes” results. If the contact information is not available locally, the first user contact information is unknown to the third user; and a “no” results. When a “yes” results in step 608, process 600 skips to step 616.

When a “no” results in step 608, a search is issued for the required contact information (step 610). The search is issued on the mobile phone network, from the third user device, for the first user contact information. Issuing an enhanced search function for searching among a set of address books initiates a search that cascades through a subset of the set of address books. Each address book in the subset of the set of address books contains shared local entries forming a subset of the social network. Each search comprises identifying a search string and a set of trusted entries from a requesting user's address book, wherein each shared local entry is a trusted entry, and searching the set of trusted entries.

User C decides to search for user A and enters the first name, surname, or any other attribute in the enhanced search in order to do a wildcard search. When user A contact information is not present in the local address book of user C, enhanced search returns a null for the search query on user A and may prompt user C wants to search the social network, when not set to search by default in the absence of local information. A search is performed in all the public entries of all the service users who are trusted entries in the address book of user C. Therefore, the query sent by enhanced search contains a search string and a subset of the address book of user C, which user C trusts and is likely to know user A. In the example, the subset of the address book will include user B.

A determination is made whether the user information is found, forming a “found user” (step 612). If the user is found a “yes” results in step 612. If a user cannot be found, then a “no” result is obtained in step 612.

When a “no” is obtained in step 612, a notify requester is performed (step 614). Notification is returned to the requester to inform the requester that the desired information cannot be located within the currently defined social network. Process 600 terminates thereafter (step 618).

When a “yes” is obtained in step 612, aggregated information is returned as contact information to the requester (step 616). For example, locating the first user contact information at the second user device in the social network in response to the request from the third user device. Locating the requested information is performed by the phone service provider that polls the address books of the contacts in the subset of the address book of user C, provided by user C. The returned result is a set of results, particularly since a wildcard search could return more than one result. This set of results is returned to user C. In this example, the set of results contains an entry of user A obtained from user B's shared address book. This is possible because user B has user C defined as a trusted member, thus allowing user C to search public part of user B address book containing user A contact information which is marked as shared by user B. The return of the first user contact information to the third user device completes the request and process 600 terminates thereafter (step 618). User C can now decide to use and make a call to a suitable entry from the result set or discard the information.

The proposed implementation will work over existing mobile technology of Short Message Service (SMS). The illustrative embodiments can also be implemented using the mobile-web technology allowing the enhanced search and the phone service provider to communicate via web based protocols. Further, to have efficient cascaded address book search, a service provider may also cache the entries to respond to needs of a particular social network.

Using an illustrative embodiment, a user in need of contact information may then request that information through the phone service provider. The requested information may be located on devices defined to belong to the requester's social network, retrieved and returned to the requester. Security and privacy are maintained through controlled access to entries in the address book information as well as control over users that may request and provide access to the respective address book information.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for locating contact information in a mobile phone network within a social network, the computer implemented method comprising;
permitting reciprocal access between a first user contact information and a second user contact information by a first user device and a second user device, and permitting reciprocal access between the second user contact information and a third user contact information by the second user device and a third user device, wherein the reciprocal access permits access to only designated shared entries of contact information;
receiving a request from the third user device to contact the first user device, wherein a portion of the first user contact information is known to the third user;
issuing a search on the mobile phone network, from the third user device to an authorized list, for the first user contact information, using the portion of the first user contact information;
locating the first user contact information in a shared local entry at the second user device in the social network; and
returning the first user contact information directly to the third user device.

2. A computer implemented method for locating contact information in a mobile phone network within a social network of claim 1, wherein the step of permitting reciprocal access further comprises:
forming a trusted pair between the first user device and the second user device and another trusted pair between the second user device and the third user device.

3. A computer implemented method for locating contact information in a mobile phone network within a social network of claim 1, wherein issuing a search further comprises:
issuing an enhanced search function for searching among a set of address books; wherein the enhanced search function cascades through a subset of the set of address books, wherein each address book in the subset of the set of address books contains shared local entries forming a subset of the social network wherein the search is restricted to only the shared local entries.

4. A computer implemented method for locating contact information in a mobile phone network within a social network of claim 1, wherein issuing a search further comprises:
identifying a search string and a set of trusted entries from a requesting user address book, wherein each shared local entry is a trusted entry; and
searching the set of trusted entries.

5. A computer program product for locating contact information in a mobile phone network within a social network, the computer program product comprising;
a computer-usable recordable type medium embodying computer executable instructions stored thereon, the computer executable instructions comprising;
computer executable instructions for permitting reciprocal access between a first user contact information and a second user contact information by a first user device and a second user device, and permitting reciprocal access between the second user contact information and a third user contact information by the second user device and a third user device, wherein the reciprocal access permits access to only designated shared entries of contact information;
computer executable instructions for receiving a request from the third user device to contact the first user device, wherein a portion of the first user contact information is known to the third user;
computer executable instructions for issuing a search on the mobile phone network, from the third user device to an authorized list, for the first user contact information, using the portion of the first user contact information;
computer executable instructions for locating the first user contact information in a shared local entry at the second user device in the social network; and
computer executable instructions for returning the first user contact information directly to the third user device.

6. A data processing system for locating contact information in a mobile phone network within a social network, the data processing system comprising;
a bus;
a memory connected to the bus, the memory comprising computer executable instructions;
a communications unit connected to the bus;
a display connected to the bus; and
a processor unit connected to the bus, wherein the processor unit executes the computer executable instructions to direct the data processing system to:
permit reciprocal access between a first user contact information and a second user contact information by a first user device and a second user device, and permit reciprocal access between the second user contact information and a third user contact information by the second user device and a third user device, wherein the reciprocal access permits access to only designated shared entries of contact information;
receive a request from the third user device to contact the first user device, wherein a portion of the first user contact information is known to the third user;
issue a search on the mobile phone network, from the third user device to an authorized list, for the first user contact information, using the portion of the first user contact information;
locate the first user contact information in a shared local entry at the second user device in the social network; and
return the first user contact information directly to the third user device.
